(19) United States
(12) Patent Application Publication
(10) Pub. No.: US 2023/0373809 A1
(43) Pub. Date: Nov. 23, 2023

(54) PROCESS FOR THE PRODUCTION OF TITANIUM DIOXIDE FROM ANATASE ORE THROUGH SULPHURIC ACID DIGESTION, FOLLOWED BY LEACHING, HYDROLYSIS, AND CALCINATION

(71) Applicants: The Mosaic Company, Plymouth, MN (US); COMPANHIA DE DESENVOLVIMENTO DE MINAS GERAIS CODEMAGE S/A, Belo Horizonte (BR)

(72) Inventors: Ana Cláudia Queiroz Ladeira, Belo Horizonte (BR); João Batista da Castro, Belo Horizonte (BR); Rafael Nogueira Brandão, Belo Horizonte (BR); Lílian Lís de Andrade Cantuário Costa, Santo Antonio (BR)

(21) Appl. No.: 18/030,632

(22) PCT Filed: Oct. 6, 2021
(86) PCT No.: PCT/US2021/053779

§ 371 Date: Apr. 6, 2023

Related U.S. Application Data
(60) Provisional application No. 63/088,289, filed on Oct. 6, 2020.

(51) Int. Cl. C01G 23/053; C01G 23/08

(52) U.S. Cl. CPC C01G 23/0532; C01G 23/08

(57) ABSTRACT

Processes to solubilize the titanium and, later, hydrolyze it as titanium dioxide, in part based on the mineral ogical complexity of the anatase ore. The process described is capable of sufficiently solubilizing titanium in anatase using H₂SO₄, while overcoming the low reactivity of the ore to this acid. Moreover, the process does not require a reduction step prior to anatase digestion.

### RELATED APPLICATION

The present application claims the benefit of U.S. Provisional Application No. 63/088,289 filed Oct. 6, 2020, which is hereby incorporated herein in its entirety by reference.

### TECHNICAL FIELD

Embodiments of the disclosure are generally related to the production of titanium dioxide, and more specifically to a process for the production of titanium dioxide from anatase ore through digestion with sulphuric acid, leaching, hydrolysis and calcination.

### BACKGROUND

Titanium dioxide, also known as titanium (IV) oxide or titania, is the naturally occurring oxide of titanium having the chemical formula TiO₂. Titanium dioxide is used in a wide range of applications, including, but not limited to, paint, pigments, toothpaste, sunscreen, pharmaceuticals, food stuffs, soaps, and food coloring.

Titanium dioxide is sourced from titaniferous ores including ilmenite which is an iron-titanium oxide with a chemical composition of FeTiO₃, rutile which is a mineral composed primarily of titanium dioxide, and is the most common natural form of TiO₂, and anatase which is a rarer, metastable mineral form of titanium dioxide. Two main processes are used to recover commercial grade titanium dioxide from these ores: a sulphate process and a chloride process. Although the chloride process has some advantages over the sulphate process in both cost and waste management, the sulphate process allows low grade titanium raw materials to be used. The decrease in rutile and ilmenite reserves makes necessary the study of other methods to obtain TiO₂. Since 1980, anatase has been studied as a source for obtaining high TiO₂ purity. However, technical and economic viability issues still remain.

Anatase is one of the titanium dioxide polymorphs, in addition to rutile and brookite, as described above. It has a tetragonal crystalline system, a specific density from 3.82 to 3.97 g/cm³, and a hardness between 5 and 6. Anatase is a low-temperature polymorph and occurs in weathered and metasomatized rocks (Moraes and Seer, 2015).

Despite being rare compared to reserves of ilmenite and of rutile, anatase ore reserves are found in Minas Gerais (Brazil), more specifically in the Tapira Alkaline-Carbonatitic Complex. It consists of a weathering mantle with anatase and ilmenite. The mass of ore in the mantle in situ is estimated between 1.0 and 1.5 billion tons, with TiO₂ grades between 12% and 15%. In the city of Tapira, in addition to being found in the geological layer, anatase is a component of the piles of waste material from the production of apatite ore. The mass of titanium ore in the piles is estimated at 200 million tons, with average TiO₂ grades from 12% to 15%.

Examples of processes that produce TiO₂ from these ores include International Application Publication No. WO 1992008816 to Chaves, EP 0475104 to Bernard et al. (hereinafter “Bernard”), U.S. Pat. No. 7,625,536 to Smith Jr. and Bernard (hereinafter “Smith Jr.”). Bernard, for example, describes digesting residues of titanium dioxide production from ilmenite in 94 to 98% sulphuric acid at a temperature of 220° C., baking the mixture between 220-300° C. (2 to 18 hours), followed by hydrolyzing and calcining the mix. Bernard also teaches that the precipitate may be treated before calcination by leaching under reducing conditions. Smith Jr. generally teaches a double leaching process, and states that iron removal from anatase that is not “pretreated by a reduction step” can be “surprisingly efficient.” Additional references such as PI 8805053 A to Paixão et al., PI 9005841 and PI 9201125 A to Chaves, PI 9100482 A and PI 9101138 A to Mendonça, describe using sulfuric leaching to remove impurities and raise the product content.

### SUMMARY

In contrast to the noted references and the Background section described above, the present disclosure seeks to solubilize the titanium and, later, hydrolyze it as titanium dioxide, in part based on the mineralogical complexity of the anatase ore. The process described in the present disclosure may be capable of sufficiently solubilizing titanium in anatase using H₂SO₄, while overcoming the low reactivity of the ore to this acid. Moreover, the present disclosure may not require a reduction step prior to anatase digestion.

Embodiments of the disclosure are directed to processes for obtaining titanium dioxide (TiO₂) from anatase ore that can include the unit operations of sulphuric acid digestion of raw ore, leaching, hydrolysis, and calcinations to produce titanium dioxide. The digestion step utilized rigorous conditions of acid concentration, high temperature, and residence time to solubilize TiO₂ as TiOSO₄. Furthermore, in embodiments of the disclosure, the anatase ore is ground to a desired particle size and is then subjected to stages of magnetic separation to remove iron oxides from the anatase ore before sulphuric acid digestion. This eliminates the need for a separate reduction step traditionally used to remove iron oxides (i.e. the Becher process) before sulphuric acid digestion. The process may be based on the following sequence of unitary operations: granulometric classification, grinding, magnetic separation at low, medium and high field, regrinding, sulphuric digestion, leaching with water, filtration, hydrolysis, precipitate washing, filtration and calcination.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a unitary operation flow chart for obtaining TiO₂ from anatase ore, according to an embodiment of the disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

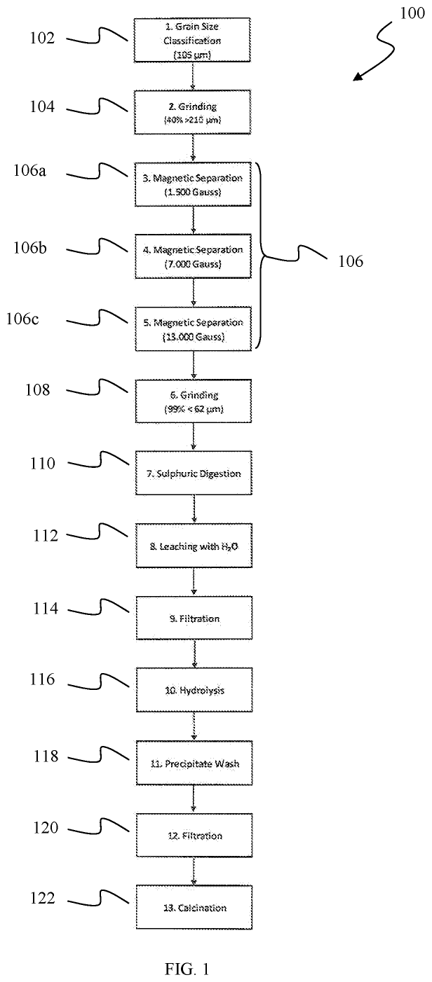

Referring to FIG. 1, a process 100 is depicted for obtaining TiO₂ from anatase ore. Process generally includes initially classifying the ore by grain size (102), grinding the ore to a desired particle size (104), magnetically separating iron oxides from the ore (106), further grinding the ore to a smaller desired particle size (108) once the iron oxides has been removed, subjecting the ore particles to acid digestion (110), leaching the digested ore with water (112), filtering the leached ore (114) to produce a filtrate and a mother liquor, subjecting the filtrate to hydrolysis (116), washing (118) and filtering (120) the precipitate, and subjecting the precipitate to calcination (122), thereby forming the end product, TiO₂. Several parameters are evaluated and optimized in process 100, including, but not limited to, ore grain size, temperature, acid concentration, ore:acid ratio, residence time, solid:liquid in leaching, so that process 100 produce satisfactory yields and purity. Furthermore, process 100 eliminates the need for a reduction step to remove iron oxides before acid digestion step 110, thereby reducing cost and increasing efficiency.

Starting with step 102, raw anatase ore is classified by grain size in a wet stage. The portion classified as −105 μm is discarded. At step 104, the classified grains +105 μm are ground to smaller size using a tubular mill. The ore is ground to a desired particle size, and in one embodiment, the desired particle size is such that about 60% of the particles are smaller than 210 μm

The ground ore is then subjected to stages of wet magnetic separation in step 106, in which the naturally occurring iron oxides in the ore are removed, thereby eliminating the need of a reduction step. In one particular non-limiting embodiment, the ground ore is depicted to three different magnetic separation steps 106a, 106b, and 106c, with increasing of magnetic field strength in each step. For example, in the first step (106a), the intensity of magnetic field is low and can be around from about 1,000 to about 2,000 Gauss, and more specifically about 1,500 Gauss. In step 106b, the non-magnetic material from step 106a is processed in a magnetic field increased to from about 6,000 to about 8,000 Gauss, and more specifically about 7,000 Gauss. Finally, in step 106c, the non-magnetic material from step 106b is put in an inducted magnetic field increased to from about 11,000 to about 15,000 Gauss, and more specifically about 13,000 Gauss. One of ordinary skill in the art would recognize more or less magnetic separation steps can be included, until the iron oxides are sufficiently removed to eliminate the need for a reduction step.

The resulting separated ore is then subjected to a second grinding step at 108, in which the separated ore is finely ground such that about 99% or more is less than about 62 μm, thereby increasing the surface area for efficient and more complete acid digestion.

In step 110, the ground ore is subjected to rigorous conditions of sulphuric acid in a concentration 98%, ore:acid ratio 1:2, temperature between 180° C. and 240° C., and residence time between about 3 hours to about 6 hours. During digestion step 110, the TiO₂ in the ore is solubilized in the form of titanium oxide sulphate (TiOSO₄), or oxotitanium sulfate, using the reaction:

TiO₂+H₂SO₄→TiOSO₄+H₂O

Once solubilized, at step 110, the titanium oxide sulphate is leached, at step 112, from the digested ore cake using water at a solid:liquid ratio of about 1:4, temperature in the reactor between 50° C. and 70° C., with mechanical agitation, residence time between about 2 and 4 hours.

The leached titanium oxide sulphate is then filtered at 114 to remove residual impurities. The filtrate, which comprises a solution of titanium oxide sulphate is then subjected to hydrolysis at step 116 to form TiO₂·nH₂O, such as heat hydrolysis. The titanium sulfate solution and the water are heated, separately, up to the temperature range between 50° C. and 75° C., and they are mixed in a liquor:water ratio 1:5, and the temperature is increase between 80° C. and 105° C. The system is kept in mild agitation and heating between about 2 and 5 hours. During hydrolysis, the hydrated TiO₂ precipitates from the solution, based on the reaction:

TiOSO₄+2H₂O→TiO(OH)₂+H₂SO₄

The precipitate, which is the hydrolyzed monomeric form TiO(OH)₂ is then washed at step 118 to removed free sulphuric acid, and filtered at step 120. Finally, at step 122, the hydrolyzed TiO(OH)₂ is calcined between 900° C. and 1,100° C. for about 1 to 4 hours, to thermally decompose the TiO(OH)₂ to TiO₂, the end product.

EXAMPLE 1: After steps 102 to 108, a physical concentrate was obtained with the composition shown in Table 01, characterized by the technique of Wavelength Dispersive X-Ray Fluorescence Spectroscopy (WDXRF).

TABLE 01
Physical concentrate's composition.

| Elements | Initial sample (%) |
|---|---|
| TiO₂ | 55.10 |
| Fe₂O₃ | 10.66 |
| SiO₂ | 9.23 |
| P₂O₅ | 7.81 |
| CaO | 5.00 |
| Al₂O₃ | 4.00 |
| SO₃ | 0.56 |
| Nb₂O₅ | 0.54 |
| MnO | 0.34 |
| ZrO₂ | 0.28 |
| SrO | 0.26 |
| K₂O | 0.10 |
| Y₂O₃ | 0.29 |
| CeO₂ | 0.36 |
| BaO | 0.45 |
| ThO₂ | 0.03 |
| Loss on ignition | 5.10 |

A mass of 20.00 grams of anatase concentrate ore was weighed, with the composition shown in Table 01, which was then subjected to the stages 110 and 112, according to the conditions in Table 02:

TABLE 02
Summary of sulphuric digestion and leaching's conditions

| SULPHURIC DIGESTION | | | | | LEACHING | | |
|---|---|---|---|---|---|---|---|
| Grain | Temperature | [H₂SO₄] | Ore:acid | Time | Time | Solid:liquid | Leached TiO₂ |
| size | (° C.) | (%) | ratio (g/g) | (hours) | (hours) | ratio (g/mL) | percentage (%) |
| 99.3% < | 220 | 98 | 1:2 | 04 | 02 | 1:4 | 81.6 |
| 62 μm | | | | | | | |

The leached TiO₂ percentage was calculated based on the final residue's chemical composition, after leaching with water. The residue mass obtained was 5.53 g, and this composition is in Table 03, characterized by Energy-dispersive X-Ray spectroscopy (EDX):

TABLE 03
Leaching residue's chemical composition

| Elements | Sample (%) |
|---|---|
| TiO₂ | 36.75 |
| Fe₂O₃ | 8.29 |
| SiO₂ | 23.90 |
| P₂O₅ | 5.40 |
| CaO | 1.88 |
| Al₂O₃ | 0.22 |
| SO₃ | 16.28 |
| Nb₂O₅ | 0.30 |
| MnO | 0.10 |
| ZrO₂ | 0.22 |
| SrO | 0.33 |
| K₂O | 0.13 |
| Y₂O₃ | 0.03 |
| CeO₂ | 0.22 |
| BaO | 0.28 |
| ThO₂ | <0.01 |
| Loss on ignition | 5.13 |

Therefore, a solubilization of approximately 81.6% of titanium was obtained. To make the hydrolysis, step 116, the liquor used was characterized by Energy-dispersive X-Ray spectroscopy (EDX) and the composition is shown in Table 04:

TABLE 04
Liquor characterization used in hidrolysis

| Elements (g/L) | Liquor (g/L) |
|---|---|
| Ti | 42.99 |
| Fe | 10.18 |
| Si | 1.83 |
| P | 4.10 |
| Ca | 0.76 |
| Al | 2.86 |
| Nb | 0.50 |
| Mn | 0.51 |
| Zr | 0.30 |
| Th | 0.026 |
| Ce | 1.52 |
| SO₄ (Total) | 280 |
| H₂SO₄ (Free) [mol/L] | 1.84 |

The liquor and water were heated separately to 60° C., using a liquor:water ratio 1:5, after this they were mixed and the temperature was raised to 95° C. After the start of hydrolysis, which can be seen visually, 10% of additional water was added. Heating and stirring were maintained for 3 hours. During the step 120, filtration, the hydrolysate was washed with water. Table 05 shows the hydrolyzated composition, before and after calcination, carried out at 950° C., for 2 hours. The concentrate obtained has 88.5% of TiO₂.

TABLE 05
Hydrolyzate chemical characterization, before and after calcination

| | Elements | | | | | | | |
|---|---|---|---|---|---|---|---|---|
| | | | | | | | | Loss on |
| | | | | | | | | ignition |
| | TiO₂ | Fe₂O₃ | P₂O₅ | SiO₂ | SO₃ | ZrO₂ | Nb₂O₅ | (450° C.) |
| Hydrolyzate's | 72.9 | 1.65 | 5.87 | 0.38 | 9.36 | 0.53 | 0.81 | 2.30 |
| composition (%) | | | | | | | | |
| Calcined's | 88.5 | 1.64 | 7.19 | 0.42 | 0.39 | 0.73 | 1.12 | — |
| composition (%) | | | | | | | | |

In some embodiments, the technical features of the present disclosure may be described by one or more of the following clauses:
1. A Technological route to obtain titanium dioxide concentrate from anatase ore, using sulphuric digestion, hydrolysis and calcination, through extreme conditions (sulphuric acid concentration, high temperature and sulphuric digestion time), so that the solubilization of titanium dioxide, in the form of titanyl sulfate, TiOSO₄, occurs.
2. A method according to any one of the proceeding clauses, characterized by sulphuric digestion being carried out under the following conditions: ore grain size 99% less than 62 μm; sulfuric acid concentration 98% by weight; ore:acid ratio 1:2; sulphuric digestion's temperature in the range of 180° C. to 240° C. and reaction time between about 3 and about 6 hours.
3. A method according to any one of the proceeding clauses, characterized by following the sulphuric digestion step using leaching with water at temperature room, with solid:liquid ratio 1:4, and the pulp kept in a range between 50° C. and 70° C., with mechanical agitation, for a period between about 2 and about 4 hours.
4. A method according to any one of the proceeding clauses, characterized in that a solid-liquid separation of the pulp after the aqueous leaching, to obtain a liquor rich in titanium and a solid leaching residue.
5. A method according to any one of the proceeding clauses, characterized by after the filtration step is make a hydrolysis step, in which the volumes of liquor and water, in a liquor:water ratio 1:5, were heated, separately, to a temperature range between 50° C. and 75° C., and subsequently mixed. Then, the temperature was increased to a range between 80° C. and 105° C. and the system is maintained by stirring and heating for a period between about 2 and about 5 hours;
6. A method according to any one of the proceeding clauses, characterized in that following the hydrolysis a filtration step and washing the hydrolysate with water, to obtain TiO₂·nH₂O.
7. A method according to any one of the proceeding clauses, characterized in that following the filtration a calcination step, at a temperature range between 900° C. and 1100° C., for a time range between about 1 and about 4 hours.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above.

The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method of producing titanium dioxide concentrate from anatase or, the method comprising:
subjecting anatase ore particles to sulphuric acid to digest the anatase ore particles thereby forming digested ore;
leaching the digested ore with water thereby forming leached ore;
filtering the leached ore to produce a filtrate and a residue;
subjecting the filtrate to hydrolysis to form a precipitate; and
subjecting the precipitate to calcination, thereby forming titanium dioxide (TiO₂).

2. The method of claim 1, wherein the digestion step takes place in conditions such that a solubilization of titanium dioxide in the form of titanyl sulfate, TiOSO₄, occurs, according to the reaction: TiO₂+H₂SO₄→TiOSO₄+H₂O.

3. The method of claim 2, wherein the sulphuric acid has a concentration of at least 98%, the ratio of ore particles to sulphuric acid is 1:2, or both.

4. The method of claim 2, wherein a reaction temperature of the digestion step is in a range of about 180° C. to about 240° C., a reaction time is in a range of about 3 to about 6 hours, or both.

5. The method of claim 1, wherein the ore particles have an ore grain size of 99% less than 62 μm.

6. The method of claim 1, further comprising:
classifying raw anatase ore particles by grain size into a first portion and a second portion;
discarding the first portion; and
subjecting the second portion to a first grinding step until about 60% of the second portion has an ore grain size of less than 210 μm.

7. The method of claim 6, further comprising, after the first grinding step:
subjecting the second portion to a magnetic separation step to remove iron oxides from the second portion such that a reduction step is not required.

8. The method of claim 7, wherein the magnetic separation step comprises, in order:
subjecting the second portion to a first magnetic field;
subjecting the second portion to a second magnetic field greater than the first magnetic field; and
subjecting the second portion to a third magnetic field greater than the second magnetic field.

9. The method of claim 8, wherein the first magnetic field is in a range of from about 1,000 Gauss to about 2,000 Gauss, wherein the second magnetic field is in a range of from about 6,000 Gauss to about 8,000 Gauss, and wherein the third magnetic field is in a range of from about 11,000 Gauss to about 15,000 Gauss.

10. The method of claim 7, wherein, after the magnetic separation step, the second portion is subjected to a second grinding step until about 99% or more of the second portion has an ore grain size of less than 62 μm.

11. The method of claim 1, wherein the leaching step is carried out at a solid:liquid ratio of 1:4.

12. The method of claim 1, wherein the leaching step is carried out at a temperature in a range between 50° C. and 70° C., with mechanical agitation, for a period between about 2 and about 4 hours.

13. The method of claim 1, wherein the filtrate is rich in titanium.

14. The method of claim 1, wherein the hydrolysis step is carried out in a filtrate:water ratio of 1:5.

15. The method of claim 1, wherein the hydrolysis step comprises:
heating each the filtrate and water are heated separately to a temperature in the range of from about 50° C. to about 75° C.;
subsequently mixing the filtrate and water;
heating the mixed filtrate and water to a temperature in the range of from about 80° C. to about 105° C.; and
maintaining, by stirring and heating, the mixed filtrate and water for a period of time in a range of from about 2 hours and about 5 hours.

16. The method of claim 1, wherein, during the hydrolysis step, hydrated titanium dioxide precipitates out of solution as the precipitate based on the reaction:
TiOSO₄+2H₂O→TiO(OH)₂+H₂SO₄

17. The method of claim 16, wherein the precipitate is filtered out of solution and washed with water to obtain TiO₂·nH₂O.

18. The method of claim 1, wherein the calcination step is carried out at a temperature in a range of from about 900° C. to about 1100° C., and for a period of time in a range of from about 1 hour to about 4 hours.

19. The method of claim 18, wherein the calcination step thermally decomposes TiO(OH)₂ to TiO₂.

20. The method of claim 1, wherein the method does not include a reduction step for removing iron oxides prior to anatase digestion.

21. A titanium dioxide product formed from the method of claim 1.
